(19) United States
(12) Patent Application Publication
(10) Pub. No.: US 2002/0010604 A1
(43) Pub. Date: Jan. 24, 2002

(54) Automated internet based interactive travel planning and reservation system

(76) Inventor: David Block, Key Biscayne, FL (US)

Correspondence Address: Allen R. Kipnes, Esq., c/o WATOV & KIPNES, P.C., P.O. Box 247, Princeton Junction, NJ, 08550, US

(21) Appl. No.: 09/875,454

(22) Filed: Jun. 6, 2001

Related U.S. Application Data
(60) Provisional application No. 60/210,498, filed on Jun. 9, 2000.

(51) Int. Cl. G06F 17/60

(52) U.S. Cl. 705/6

(57) ABSTRACT

An interactive rapid response Internet accessed air travel planning and reservation system responds either via voice communication or data communication, to details of a member's desired travel, to thereafter act in real time to contact the domains of associated travel service providers to arrange for every aspect of the member's trip, from airline and hotel reservations, ticket issuance, and ground transportation, to restaurant and theater reservations, and any other travel related needs of the member.

### BACKGROUND OF THE INVENTION

Over the past ten years both business and personal travel have been increasing at a dramatic rate. In order to accommodate and facilitate the increased travel being made by both business and personal travelers, whether by air, train, ship, bus, limousine, or personal automobile, much time, effort, and expense has been made on an ongoing basis by the travel industry. The travel industry includes airlines, railroads, hotels, rental car companies, limousine companies, credit card companies, and many other players such as limousine companies, restaurants, travel agents, and so forth. It is important to the travel industry as a whole, and particularly to the airline industry, to provide user friendly and rapid response reservation and travel planning systems. Such efforts have led the industry to make extensive use of the Internet, for permitting travelers to make numerous travel arrangements and plans through use of their personal computer linked to the Internet to access a desired travel related website. However, it is recognized that the travel industry has much room for improvement in providing travelers easier, less expensive, more user friendly, and faster methods and systems for both planning travel needs, and making appropriate reservations for such travel.

### SUMMARY OF THE INVENTION

An object of the present invention is to provide an improved method and system for enabling travelers to rapidly and interactively communicate via the Internet with desired websites for making all necessary travel arrangements for a desired trip.

It is another object of the invention to provide travelers with a means for making last minute ticketing reservations with travel carriers, simultaneous with planning their itineraries.

Yet another object of the invention is to provide travelers with a means for receiving alerts and travel advisories at any given time, no matter where the traveler or user of the inventive system might be located.

With these and many other objects in mind, the present invention provides a method and system that permits travelers to register as members for receiving access to the main website of the system, that interactively provides the member with access to numerous other websites for facilitating whatever travel arrangements the member wishes to make. The member is provided with means to log onto the system website through use of the member's personal computer, mobile telephone, held hand palm computer, web tv, Internet cell phone (iCell phone), and cell phone, for communicating through the system to secure travel reservations with air, land, and sea carriers, and to secure reservations for lodging, restaurants, entertainment, and other desired services. The system includes voice recognition means for permitting a user to communicate via voice commands, even while the user or member may already be pursuing travel on a last minute basis, while using the system to complete all further and necessary travel arrangements. The system further provides means for permitting a member to select specific travel carriers or service providers, and also provides means for analyzing the general travel requirement of the user, such as a desired airport, departure date and time, arrival city, length of stay, and so forth. The system will provide a user with reservations for a carrier best able to meet the members travel needs, hotel reservations, limousine services, and so forth, all as based upon a members previously provided travel preferences, and personal needs, all of which are stored in the system in the member's portfolio.

### BRIEF DESCRIPTION OF THE DRAWINGS

Various embodiments of the invention are described in detail below, with reference to the drawings, in which like items are identified by the same reference designation wherein:

FIG. 1 shows a simplified block schematic diagram of a computer system connected to the Internet for providing the home website for the present invention that provides a Portal for members to obtain desired travel services;

FIG. 2 is a simplified block schematic diagram showing how members can communicate through the Internet with the system website of the present invention;

FIG. 3 shows a pull down menu for an embodiment of the invention for selectively obtaining flight information, or traveler information, or park/drive information, or weather information, or shopping information, and also for addressing a Portal for selecting a particular airport;

FIG. 4 shows a pictorial diagram of a pull-down menu of the invention obtainable from the pull-down menu of FIG. 3 for permitting rapid selection of a particular airport website from a plurality of addressable airport websites;

FIG. 5 shows a pull-down menu of the invention for choosing a departure and an arrival airport by name, and specific information regarding the selected airport;

FIG. 6 shows a pull-down menu of the invention relative to selection of a particular airport;

FIG. 7 shows a pull-down menu of the invention for a particular airport for accessing desired information;

FIG. 8 shows a pull-down menu of the invention obtained through selection of the sub-menu of FIG. 7;

FIG. 9 shows a pull-down menu of the invention for obtaining connecting passenger information;

FIG. 10 shows a pull-down menu of the invention for obtaining departing passenger information, and other information;

FIG. 11 shows a pull-down menu for obtaining arriving passengers information, for an embodiment of the invention;

FIG. 12 shows a pull-down menu of the invention for obtaining “General Information/Passenger Information;”

FIG. 13 shows a pull-down menu of the invention for obtaining “Justntime ticketing;”

FIG. 14 shows a pull-down menu of the invention for obtaining certain “Passenger Information;”

FIG. 15 shows another pull-down menu of the invention for obtaining information regarding the concourse of an airport, and the type of airport;

FIG. 16 shows a pull-down menu of the invention for obtaining arrival and departure flight information for a particular airport;

FIG. 17 shows a pull-down menu of the invention for obtaining additional flight information specific to the time and date of flights at a particular airport;

FIGS. 18 through 21 show flowcharts detailing the various steps for a method of the invention for permitting a member or user to make travel reservations and arrangements or plans; and

FIG. 22 shows an example of an E-Ticket for one embodiment of the invention.

### DETAILED DESCRIPTION OF THE INVENTION

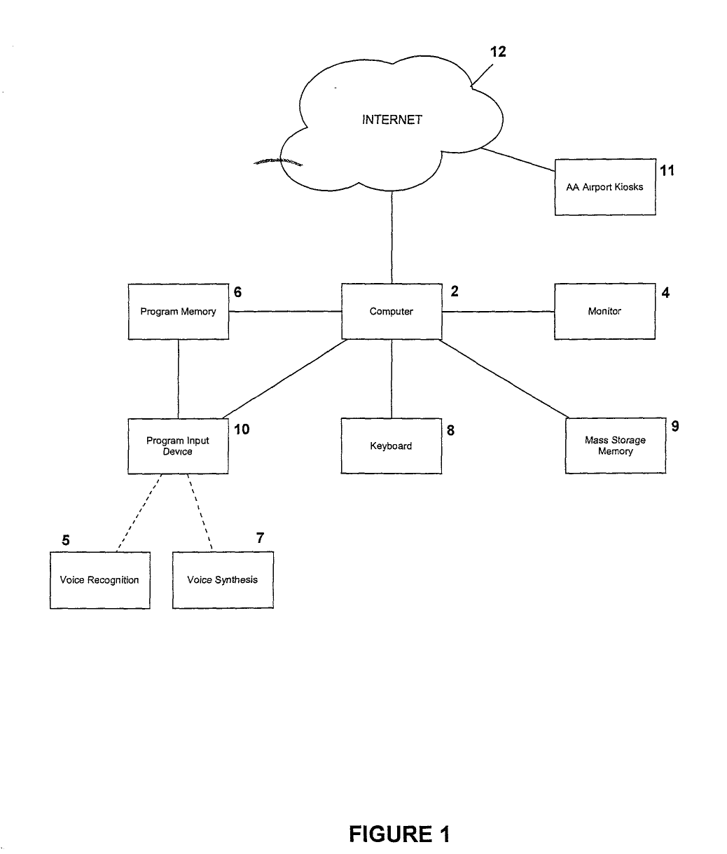

As shown in FIG. 1, a computer 2 connected to a monitor 4, program memory 6, and input device 10, are necessary for providing the web site of the present system. The computer 2 is connected to the Internet 12 for permitting members or system users access to the main website of the system. For purposes of illustration, the present invention is described below mainly in association with air travel, and trip planning and reservations associated with such travel, including preflight and post flight travel. However, the invention is not meant to be so limited, and is equally applicable in association with multiple other forms of travel beside air travel, including railroad travel, ship travel, and so forth. With further reference to FIG. 1, note that the program memory 6 is loaded with programs via the program input device 10 for providing the operating system of the present invention, and necessary programming for carrying out the methodology of the invention. Programs for voice recognition 5, and voice synthesis 7 are used in one embodiment.

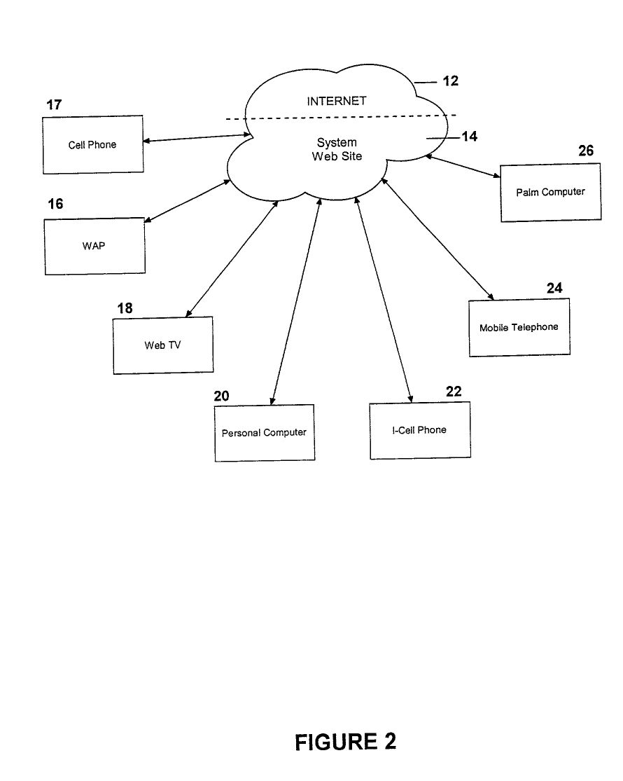

Access to the website of the system is via the Internet 12, as previously indicated. As shown in FIG. 2, members or users of the present inventive system can gain access to the system website 14 via a number of available devices. As shown in FIG. 2, these devices include but are not limited to a Wireless Application Protocol (WAP) 16, a cell phone 17, a WebTV 18, a personal computer 20, an iCell phone 22, a mobile telephone 24, or a palm computer 26. As will be described in greater detail below, users of the system must join or become members. Each member has a profile stored within the system in association with the members PIN number. Note that at the present time the inventor has named the present system “AirportAmerica” (A Trademark of AirportAmerica.com). In portions of the following description, AirportAmerica is referred to under the acronym “AA” (A Trademark owned by AirportAmerica.com).

In order for a user to have access to the present system, the user must first enroll on the system. In doing so, the user must provide a profile including name, address, telephone number, credit card information, desired class of air travel (e.g., coach, business, first) airline carrier preference, seating preference, self park or valet parking, rental car preferences, and so forth. The users profile is stored in the system, and the user is provided a PIN number, to permit the new member user to gain access to the system.

Once access is obtained, the user is presented a home page, where the user or member can then select a number of pull-down menus for making reservations and other travel arrangements. As previously indicated, the member can make various selections through direct inputs from a personal computer 20, or WebTV 18, whereby typed data or cursor selected responses are provided to the system 14. Otherwise, voice commands can be used via an iCell phone 22, or the mobile telephone 24, or cell phone 17, for example.

AA will provide each of the major airports a standardized website; this benefits the airport because of increased connectivity, and benefits the AA member in that all airports have the same familiar format. For those airports that choose not to participate, AA already owns domain names of those airports, commonly known as identifiers and monikers for each of those airports that can be accessed through the internet and then linked to the AA hub.

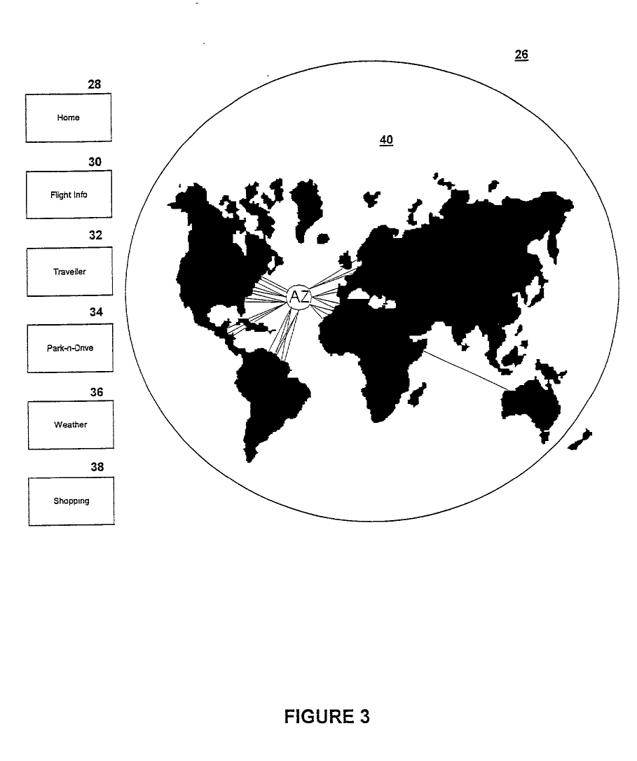

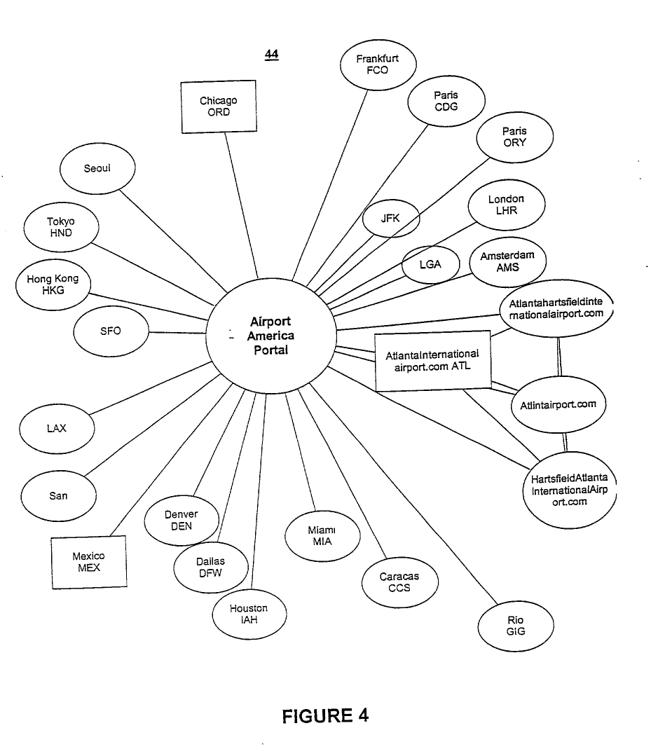

A pull-down menu 26 can be obtained, as shown in FIG. 3. Through use of this menu, a user or member can select flight information, traveler information, parking and related driving information, weather information, and shopping information, relative to a particular flight. With regard to the flight itself, first the member must select a particular airport for departure, and another airport for arrival. In one embodiment of the invention, the member moves a cursor into the world map region 40, and selects the central Portal 42, to obtain the pull-down menu 44 of FIG. 4. By placing the cursor on any one of the identified airports shown in FIG. 4 by both airport name, and code, the member then obtains access to that particular airport in a very particular manner. Once the airport is selected, the member can return to the pull-down menu of FIG. 3 for selecting specific information relative to that airport, as provided on the left hand side of the pull-down menu 26.

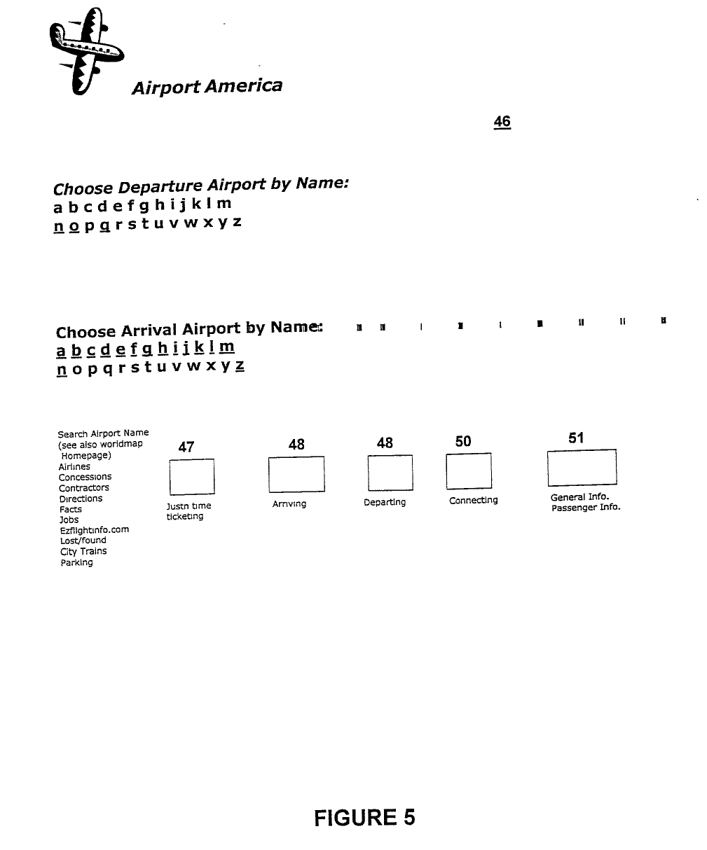

The member can also select a pull-down menu 46, as shown in FIG. 5, for selecting a departure airport by name, and an arrival airport by name. Once the airports are selected, the member can click onto any one of the word icons shown, such as 47 through 51, for example, or on any one of the icons shown at the left of menu 46.

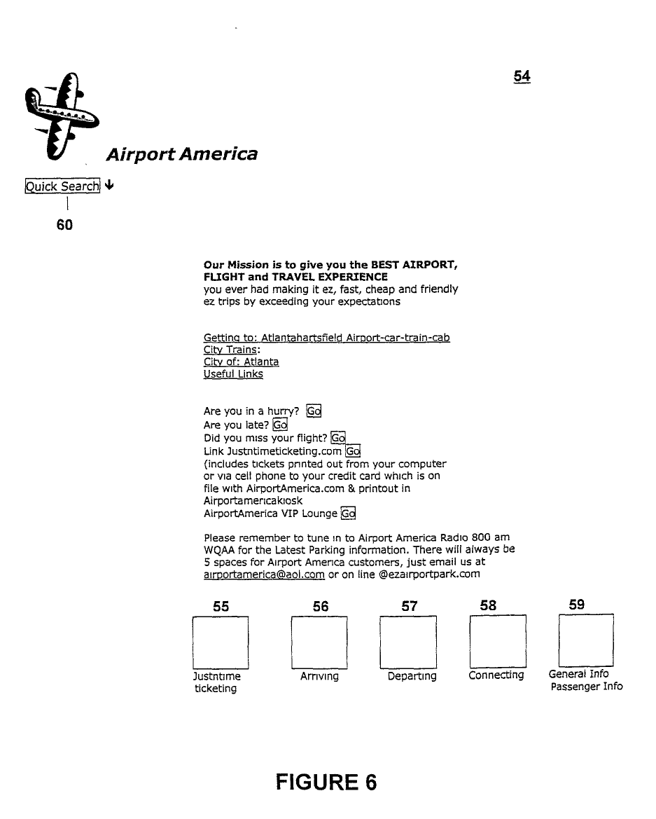

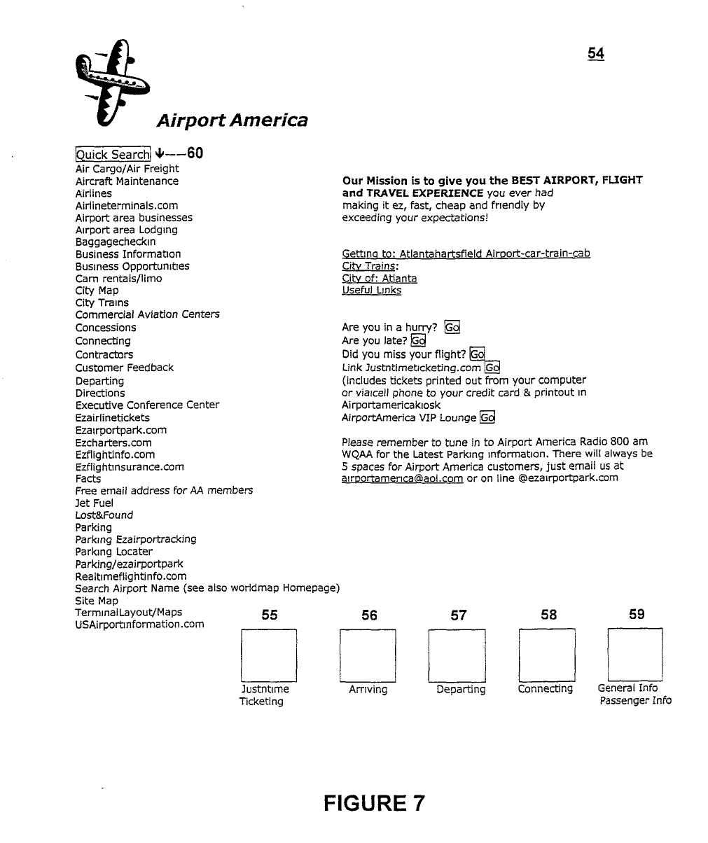

The member can also select the pull-down menu 54 of FIG. 6, for obtaining specific information relative to a particular airport, and for answering certain questions as indicated, for permitting direct access to other pull-down menus to permit the member to pursue various options associated therewith. In the pull-down menu 54, an airport name has been inserted into “Getting To:”, and the city associated with the airport, in this example, Atlanta, Ga. Any of the word icons, as shown can be addressed for providing or obtaining certain information, as indicated. For example, anyone of the word icons 55 through 59, can be individually addressed for obtaining the indicated function, or information. The member can also address the icon Quick Search 60, shown in the upper left in the pull-down menu 54. If the member does address Quick Search 60, the pull-down menu 54 will be modified as shown in FIG. 7, to present word icons for selection by the member via the “Quick Search 60” function.

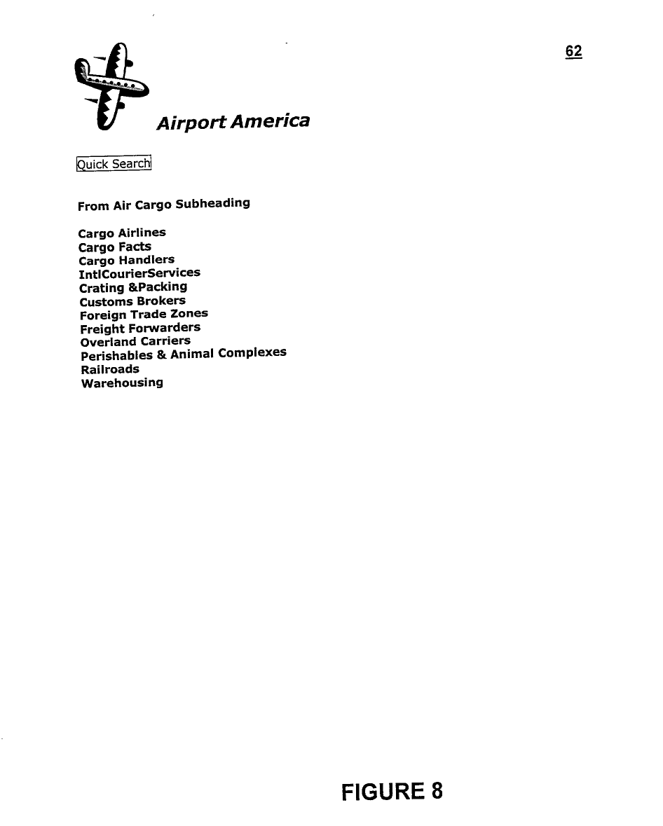

With further reference to the modified pull-down menu 54 of FIG. 7, assume for example that the member selects the icon “Aircargo/Air Freight.” If so, the pull-down menu 62 of FIG. 8 will be obtained. The member can then address any one of the icons indicated at the left, for obtaining detailed information associated therewith, such as “Warehousing.”

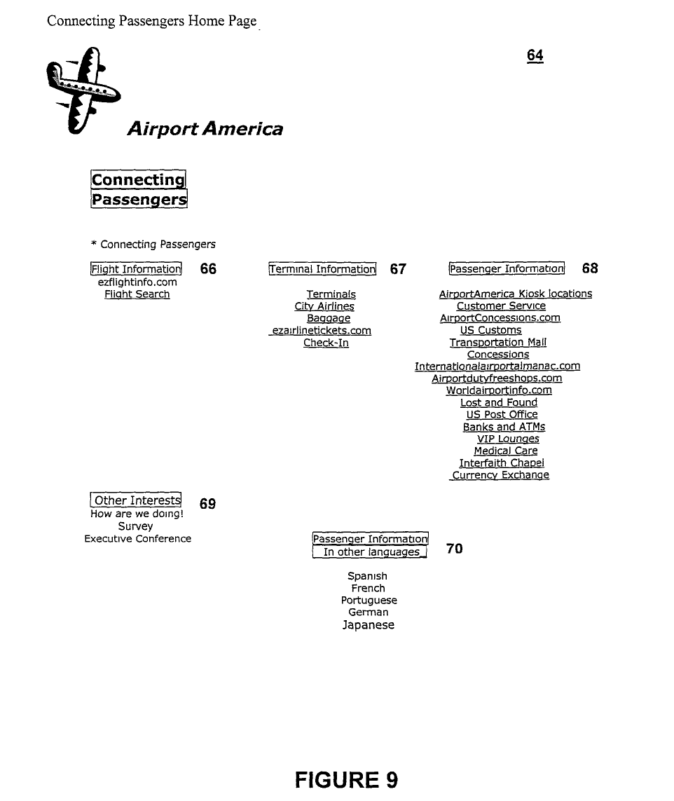

A member can also select the pull-down menu 64, as shown in FIG. 9, for obtaining information about “Connecting Passengers” by individually addressing any one of the icons under the headings Flight Information 66, Terminal Information 67, Passenger Information 70, or “Other interests” 69, the member can obtain indicated information relative to Connecting Passengers. Also, by selecting anyone of the icons under “passenger information in other languages,” the member can select a desired language other than English.

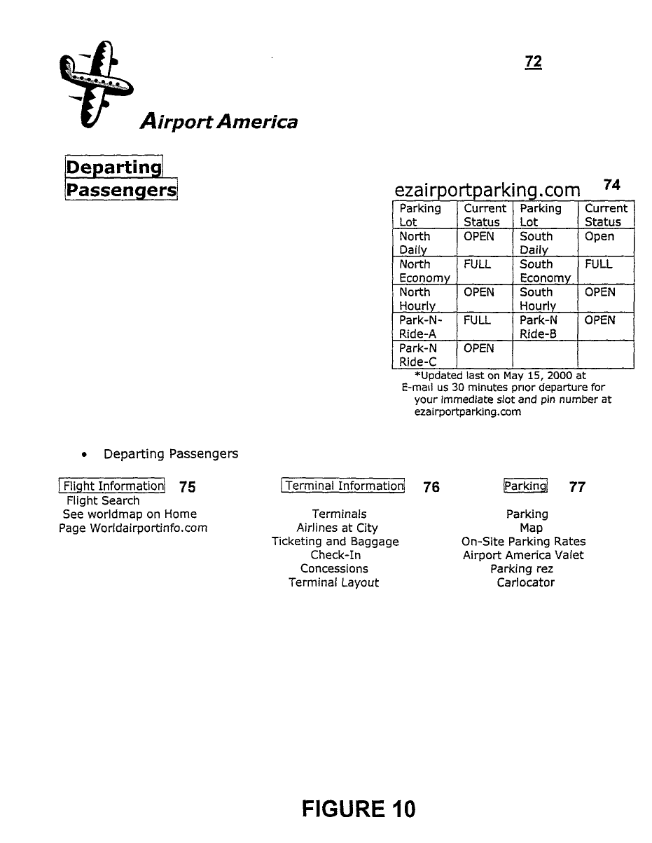

The member can select the pull-down menu of 72 of FIG. 10, for obtaining information relative to “Departing Passengers.” Note that for the particular airport, icons are provided for obtaining Parking Information 74, Flight Information 75, Terminal Information 76, and other detailed “parking” 77 information.

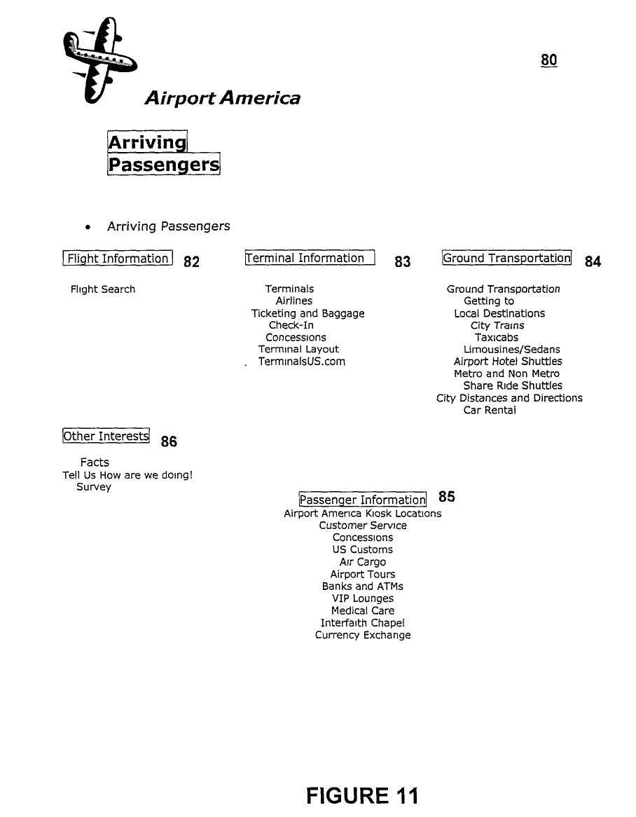

The pull-down menu 80, for obtaining information relative to “Arriving Passengers”, as shown in FIG. 11, can be selected. Various of the icons shown can be addressed for obtaining Flight Information 82, Terminal Information 83, Ground Transportation Information 84, and Passenger Information 85. Also, by addressing the icons under Other Interests 86, other facts can be obtained, and also the member is provided an opportunity for letting AirportAmerica know how they are doing in providing the related service.

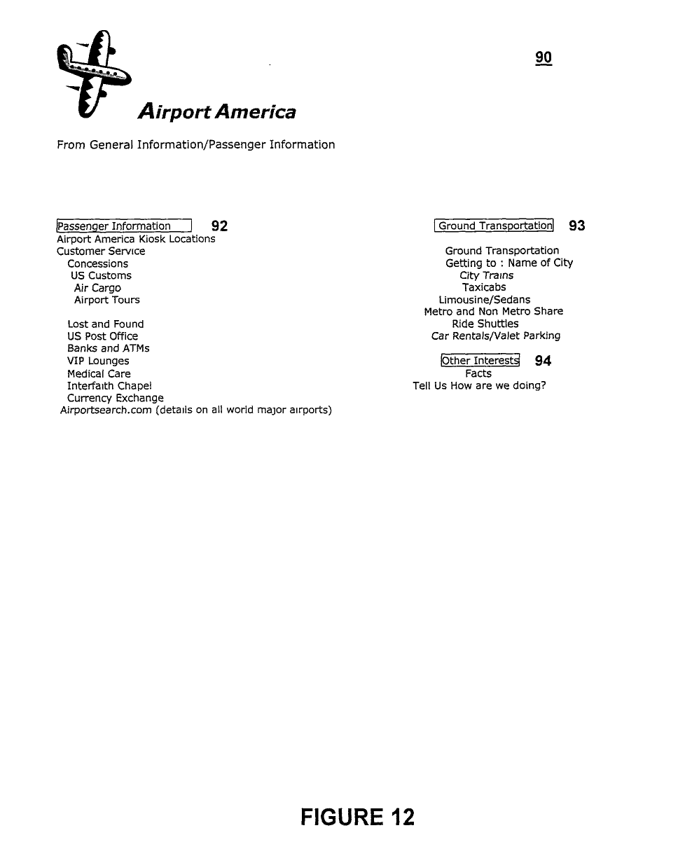

The pull-down menu 90, shown in FIG. 12, can be obtained for gaining Passenger Information 92, Ground Transportation 93, and Other Interests 94, by addressing the respective icons associated therewith, as shown.

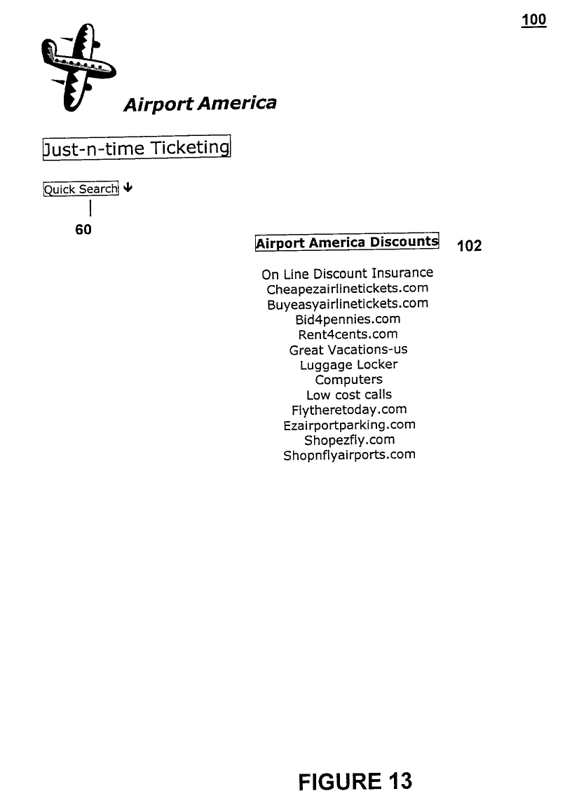

If in the pull-down menu 46 of FIG. 5, or the pull-down menu 54 of FIGS. 6 and 7, the member selected “Justntime ticketing 47” relative to flowchart 46, or the same function indicated as 55 in the flowchart 54 of FIGS. 6 and 7, the pull-down menu 100 of FIG. 13 will be obtained. As shown, a Quick Search 60 can be addressed, and the individual icons under “AirportAmerica discounts 102” can be addressed for obtaining associated information as indicated by each icon.

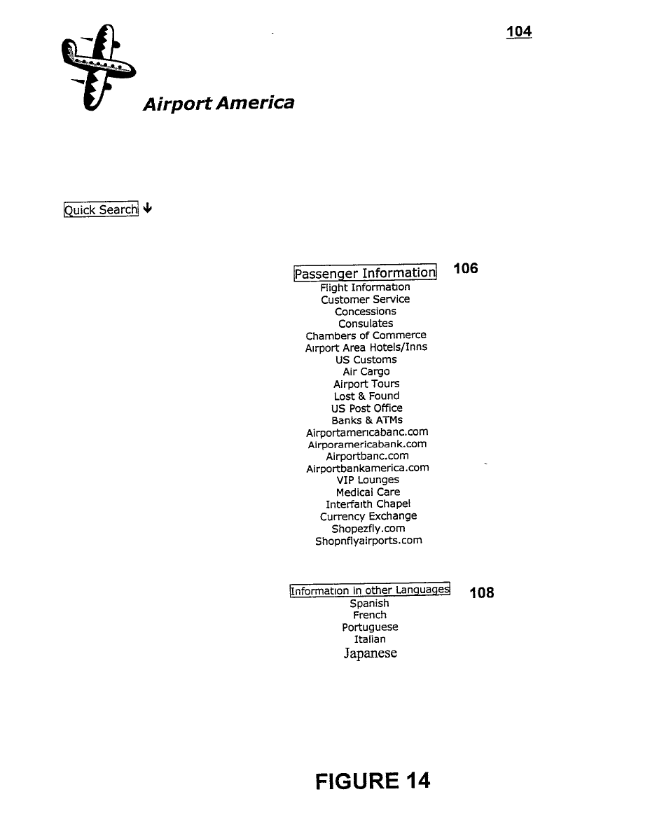

The pull-down menu 104, shown in FIG. 14, can be obtained for obtaining specific “passenger information” 106, as shown by the individual and selectable icons thereunder. Also, as shown under “Information in other languages” 108, a member can select other than English.

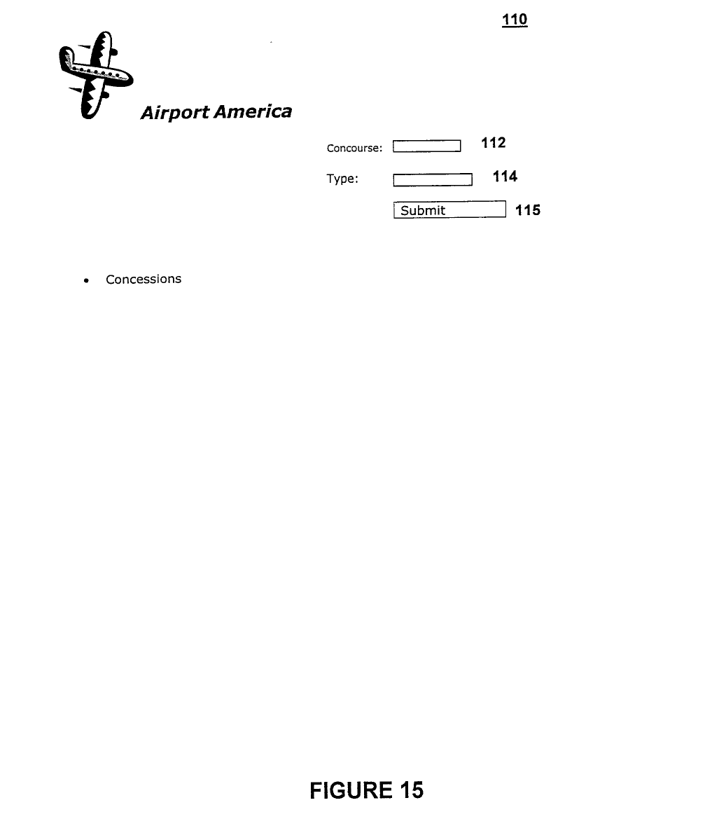

The pull-down menu 110 of FIG. 15 can be obtained for a specific airport, for obtaining information regarding a Concourse 112 of the airport, in a particular “Type” 114 concession associated therewith by inputting the appropriate information, and submitting it, the system will provide the location of the particular concession in that concourse. As shown, after inputting the information desired, the member must address the icon 115 for submitting the same.

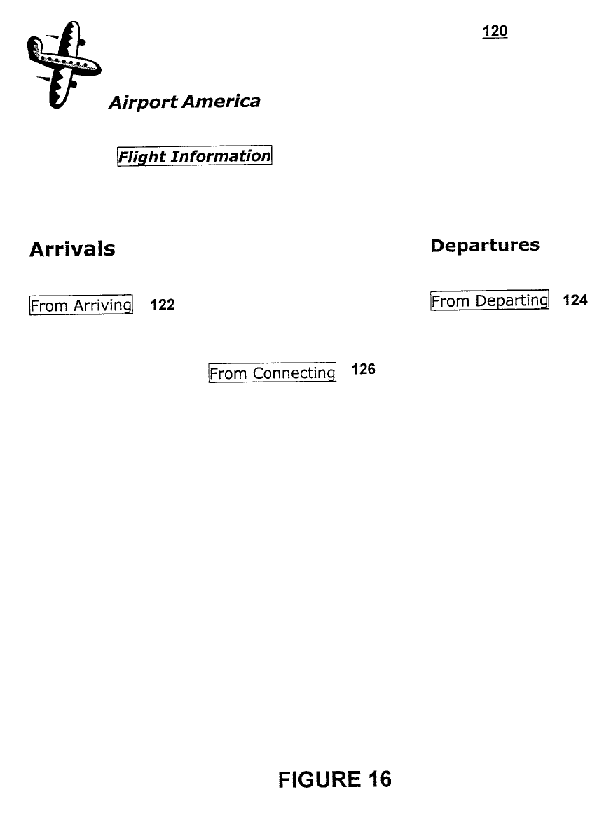

The pull-down menu 120 for showing “Flight Information” can be obtained as shown in FIG. 16. The icons “From Arriving” 122, “From Departing” 124, or “From Connecting” 126 can be individually addressed for obtaining information associated with the indicated functions.

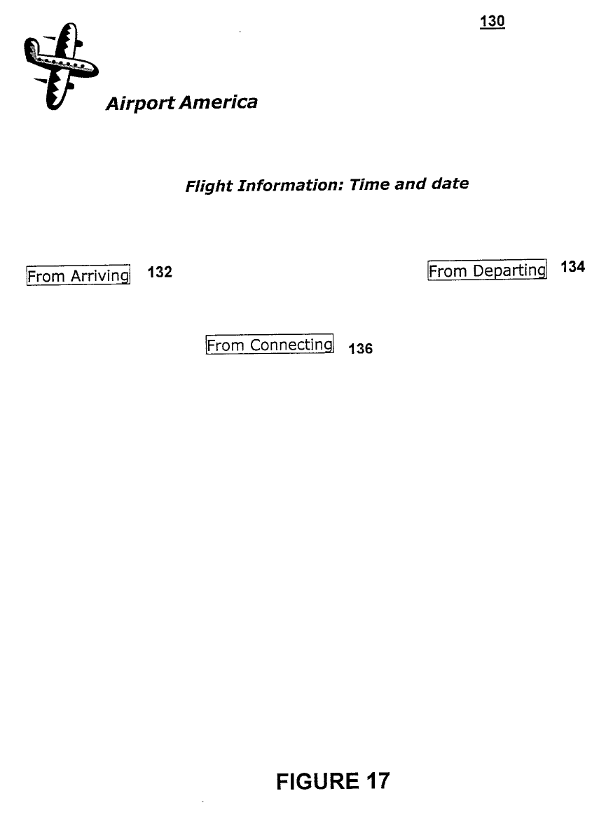

The pull-down menu 130, as shown in FIG. 17, can be selected for obtaining flight information associated with a particular time and date to be inputted into the flowchart 130 by the member. Once the time and date are provided, the member can then select individually the icons “From Arriving” 132, “From Departing” 134, and “From Connecting” 136.

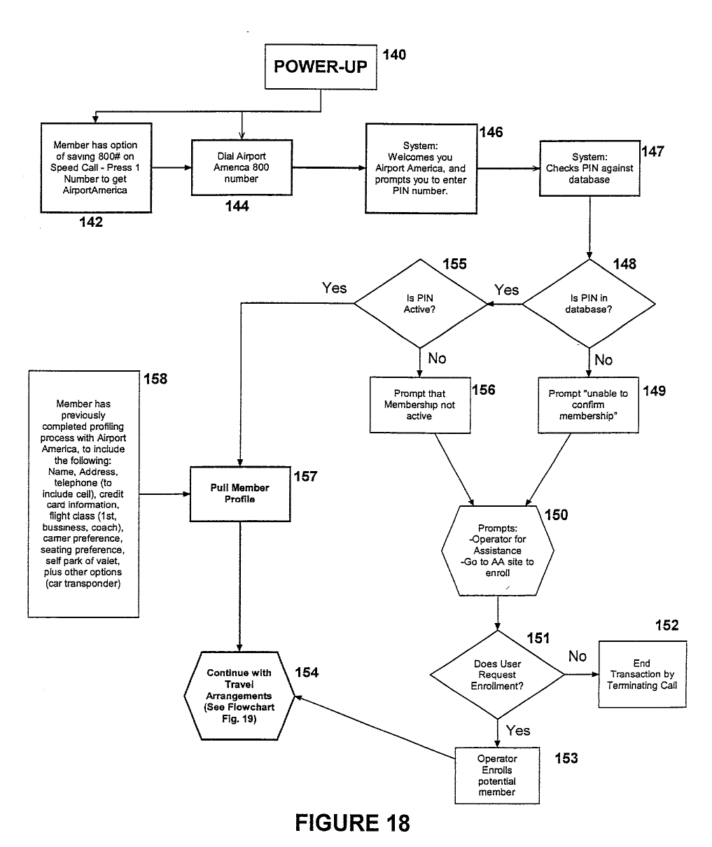

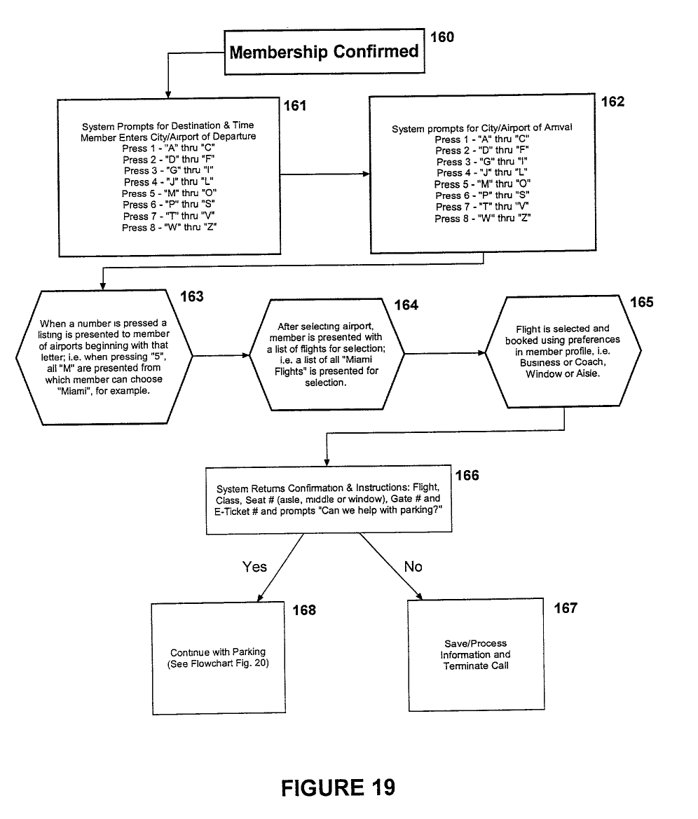

An example of various steps involved in a member using the present system, and the steps required of the System, is illustrated in the flowcharts of FIGS. 18 through 21. With reference to the flowchart of FIG. 18, the first step 140 is for the member to turn on or “power-up” his/her device for entering the Internet 12 to obtain access to the system website 14. Next, the member either uses speed dialing via step 142, or direct dialing via step 144 for dialing up AirportAmerica's 800 number. In step 146, the system welcomes the member, and prompts the member to then enter the PIN number. Thereafter, steps 147 through 152 are performed, and the transaction is ended by terminating the call (step 152), if in the sequence of prior steps, a PIN number, or membership cannot be confirmed, as indicated. If in the sequence of steps 147 through 151, a user requests enrollment via step 153, enrollment is completed, and step 154 is processed for entering into the steps of the flowchart of FIG. 19. Alternatively, if in step 148 a valid PIN is uncovered in the database, step 155 is entered for determining whether the PIN is active. If the answer is no, step 156 is entered for prompting the user that their membership is not presently active, followed by steps 150, and 151 for determining whether the user requests enrollment, as previously indicated. As before, if enrollment is not requested, step 152 is entered for ending the transaction, or if enrollment is requested, steps 153 and 154 are pursued. Lastly, if in decision step 155, the PIN is determined to be active, step 157 is entered for obtaining from memory 9 the information shown in block 158 for the identified member. Processing then proceeds to step 154 for transferring to the steps shown in the flowchart of FIG. 19.

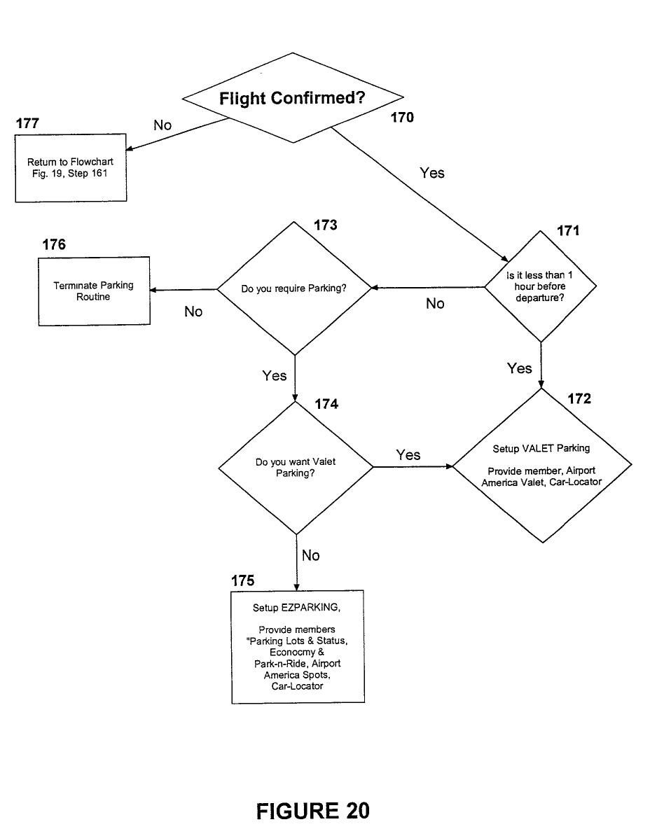

With further reference to the flowchart of FIG. 19, with membership confirmed via step 160 by transfer from step 154, steps 161 through 166 are carried out as indicated. As shown in step 166, if the member does not request help with parking, step 167 is entered for saving the processed information, and terminating the call. However, if the member does request help with parking, step 168 is entered for transferring to the steps of the flowchart of FIG. 20.

With further reference to the flowchart of FIG. 20, step 170 is entered for confirming the flight information. If the flight is confirmed, next in step 171 it is determined whether there is less than one hour before departure time. If the answer is yes, step 172 is entered for setting up valet parking. If there is more than one hour before the flight departure, step 173 is the next step after step 171, for prompting the member as to whether they require parking. If so, step 174 is entered to prompt the member for valet parking. If valet parking is selected, step 172 is next entered for taking the necessary steps to set up the valet parking, and notifying the member of the details. Alternatively, if the member choose ezparking, step 175 is entered for setting up the reservation of a parking spot, and providing to the member the parking lot information. Note also in step 172, for setting up valet parking, after doing so, the member is provided with the location and directions for going to the valet parking area.

A member can plan to make all arrangements for their return flight in a similar manner. The member can do so at a later time, or at the time of first making the arrangements for the initial departing flight, by returning to the pull-down menu of FIG. 5, and addressing one of icons 47 through 51, or some combination thereof, for obtaining the appropriate reservations and required information. The system would establish the return flight using the steps of the flowcharts of FIGS. 19 and 20, as previously described.

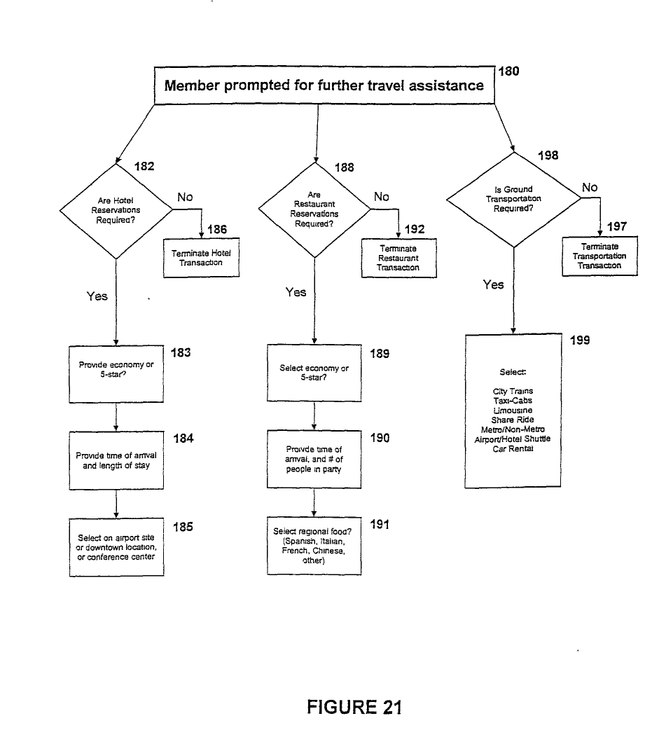

After the member has completed their flight reservations, the system operates to prompt the member for further travel assistance as shown by step 180 in the flowchart of FIG. 21. A pull-down menu will be presented having icons asking the member whether they require hotel reservations, restaurant reservations, ground transportation, and so forth. The system responds as shown in the flowchart of FIG. 21, to the members selections. If in step 182 the member confirms that hotel reservations are required, the member is further prompted in step 183 to indicate whether economy, five star, or some other class of hotel or lodging is needed. Next in step 184, the member is prompted to provide their time of arrival, and length of stay. Next, in step 185, the member is prompted to select their desired hotel location, as indicated in the flowchart. If hotel reservations are not required, step 186 is entered for terminating the hotel transaction. Similarly, if restaurant reservations are required via prompting step 188, steps of 189 through 191 are carried out as prompting steps to permit the system to then automatically make the necessary restaurant reservations. If restaurant reservations are not required in step 188, the transaction is terminated in step 192. If ground transportation is required via step 198, prompt step 199 is entered for requesting the member to select one of the indicated modes of transportation. Once the member indicates their choice, the system responds by arranging the necessary transportation, and advising the member of the arrangements made. Note that the member is prompted in each of steps 182, 188, and 198 to advise whether or not hotel, restaurant, and/or ground transportation reservations are required to ensure the member does not in making hasty travel plans forget to pursue the same. Also, the system depending upon the mode of communication with the member, will either present a screen display of the reservations made, or provide a voice synthesized message of the same for the requested hotel, and/or restaurant, and/or ground transportation arrangements made.

With further reference to FIG. 4, the present AA system utilizes the following airport related domain names owned by AirportAmerica.com:

1clickbagchk.com

1clicktx.com

aapreclear.com

aaaairdiscounts.com

aaaairfare.com

aaaairport.com

aaaairport.net

aaaairportal.com

aaaairporthotel.com

aaaairporthotels.com

aaaairportinns.com

aaaairports.com

aaaairports.net

aaaairportstay.com

aaaairtravel.com

aaaairtrips.com

aaaamsterdamairport.com

aaacheapairtix.com

aaacheaptix.com

aaachicagoairport.com

aaachicagoairports.com

aaachinatrips.com

aaacorpsuites.com

aaadiscounttix.com

aaafrankfurtairport.com

aaahongkongairport.com

aaaintlairports.com

aaairportpark.com

aaairportvalet.com

aaairportvaletpark.com

aaairportworld.com

aaairtx.com

aarentacar4u.com

aaarentacar.com

aaasuites.com

aaaticketrez.com

aaavalet.com

aaaworldairports.com

aabeamtx.com

aairportpark.com

aairportvalet.com

aakiosk.com

aaticketrez.com

aatx.com

aeropuertointernacionaljosemarti.com

aeropuertosdeestadosunidos.com

aeropuertosdemiami.com

aeropuertosdemiami.net

aeropuertosus.com

aeropuertosusa.com

airlineterminals.com

airport2airport.com

airportalmanac.com

airportalmanac.net

airportamerica.com

airportamericabanc.com

airportamericabank.com

airportapartments.com

airportapartments.net

airportapartmentsuites.com

airportbackahouse.org

airportbanc.com

airportbancamerica.com

airportbankamerica.com

airportco.com

airportconcessions.com

airportdomain.com

airportdutyfreeshops.com

airportfueling.com

airportfurnishedapartments.com

airporthotelsuites.com

airporthotelsuites.net

airportinc.com

airportindustrial.com

airportinformation.net

airportinfrastructure.org

airportjetfuel.com

airportmotel.net

airportmotelsearch.com

airportoffices.net

airportofficesuite.com

airportrans.com

airportrentals.net

airportsamerica.net

airportsbackhouse.org

airportsroundtheworld.com

airportsrus.com

airportsrus.net

airportsuites.com

airportsus.com

airportsusatoday.com

airportsusatoday.net

airportsworldb2b.com

airportus.com

airportvalet4u.com

airportvaletpark.com

airportvillas.com

airportwarehouse.net

airportworldalmanac.com

alaskaairport.com

alaskaairports.com

alaskaairports.net

alaskavacations.net

allaboutairports.com

almacenaeropuerto.com

amsairport.com

amsterdamairportinfo.com

amsterdamairportschiphol.com

amsterdamairportschipol.com

amsterdamamsairport.com

amsterdamintairport.com

amsterdamschiphol.com

ancairport.com

anchorageintairport.com

apartamentosdelaeropuerto.com

apartamentosdemiami.com

apartmentsus.net

apartmentsusa.net

asiaairtrips.com

atlantaairport.net

atlantaairportapartments.com

atlantaairportcarrentals.com

atlantaairportcorporatesuites.com

atlantaairporthotel.com

atlantaairporthotels.net

atlantaairportlodging.com

atlantaairportlodging.net

atlantaairportmotels.com

atlantaairportmotels.net

atlantaairportoffices.com

atlantaairportrentalcars.com

atlantaairports.com

atlantaairportsuites.com

atlantaairporttransportation.com

atlantaairportwarehouses.com

atlantahartsfieldinternationalairport.com

atlantahartsfieldinternationalairport.net

atlantainternationalairport.com

atlantainternationalairport.net

atlhartsfieldairport.com

atlhartsfieldintlairport.com

atlhartsfieldintlairport.com

atlintairport.com

atlinternationalairport.com

atlintlairport.com

ausairport.com

austinairport.net

austinausairport.com

b2bairport2airport.com

b2bairportcargo.com

b2bairportfreight.com

b2busairports.com

b2bworldairports.com

bahamatrips.com

baltimorewashingtonintlbwiairport.com

bancamericaairports.com

bangkokairport.net

bankamericaairport.com

bankamericaportal.com

banknairports.com

beijingairport.net

beijingchinaairport.com

beijingpekairport.com

berlintxlairport.com

bid4pennies.com

bkkairport.com

bogotaairport.com

bogotaairport.net

bosairport.com

bostonairport.net

bostonloganintairport.com

brusselsbruairport.com

buenosairesairport.com

buenosairesairport.net

buenosairesezeizaintlairport.com

bushhoustonairport.com

bushhoustonintairport.com

bushhoustonintercontinentalairport.com

bushintairport.com

bushintercontinentalairport.com

buyeasyairlinetickets.com

bwiintairport.com

caracasairport.com

caracasairport.net

caracasintlairport.com

caracasmaiquetiaintlairport.com

ccsairport.com

cghairport.com

charlotteairport.net

charlottecltairport.com

charlotteintlairport.com

cheapairportfuel.com

cheapairportoffice.com

cheapchinatrips.com

cheapezairlinetickets.com

cheaptx.com

chicagoairports.net

chicagoairtrips.com

chicagointernationalairport.com

chicagoohareairport.net

chicagoohareintairport.com

chicagoohareinternationalairport.com

chicagoohareinternationalairport.net

chicagoord.com

chicagoordairport.com

chicagotairrips.com

chinaairport.net

chinaairports.net

cincinnaticvgairport.com

cltairport.com

coloradospringsairport.net

cvgintairport.com

dallasairport.net

dallasairports.com

dallasftworthairport.com

dallasftworthairport.net

dcaairport.com

dcnationalairport.com

denairport.com

denintairport.com

denverairport.net

denverairports.com

departamentosmiami.com

detroitairport.net

detroitwaynecntymetroairport.com

dfwintairport.com

dfwintlairport.com

dfwterminal.com

diaairport.com

discountfueling.com

disneyworldairport.com

dtwairport.com

dtwmetroairport.com

eairportcommerce.com

easyairlinetickets.com

easyairportvalet.com

europeairtrips.com

everyairport.com

ewrairport.com

experiencedsecretary.com

ezaircharter.com

ezaircharters.com

ezairlinetickets.com

ezairportfuel.com

ezairportoffice.com

ezairportpark.com

ezairportparking.com

ezairportvalet.com

ezbaggage.com

ezcheapairportfuel.com

ezcheapfuel.com

ezcheckn.com

ezchinatrips.com

ezeintairport.com

ezeverest.com

ezfastairports.com

ezfastairports.net

ezflightinfo.com

ezflightinsurance.com

ezjetfuel.com

eztixrez.com

eztxrez.com

ezweathercheck.com

ezweatherchk.com

ezworldairports.com

fastezairports.com

fastezairports.net

fcoairport.com

fllairport.com

floridakeyshotelrooms.com

flyatlantaairport.com

flyaustraliaairports.com

flybeach.com

flybeaches.com

flybrasilia.com

flychicagoairport.com

flychinatrips.com

flydenverairport.com

flyeuropeairports.com

flymexicocity.com

flymountains.com

flynassau.com

flyoverseasairports.com

flytheretoday.com

flyusairport.com

flyusairports.com

flyusatoday.net

flyustrips.com

fraairport.com

frankfurtairport.net

frankfurtfraairport.com

frankfurtintairport.com

freeairtx.com

freeportintlairport.com

ftlairport.com

ftlairport.net

ftlauderdaleintlairport.com

ftlauderdaleintlairport.net

ftlauderdalintl.com

gigairport.com

giveutix.com

giveutx.com

givutix.com

habanacubaaeropuerto.com

hartsfieldatlantainternationalairport.com

hartsfieldatlantainternationalairport.net

havanainternationalairport.com

havanajosemartiairport.com

helsinkihelairport.com

helsinkivantaaairport.com

higheverest.com

highhimilaya.com

himalayatrips.com

hkgairport.com

hkinternationalairport.com

hndairport.com

hnlairport.com

hongkongairports.com

hongkongairtrips.com

hongkonginthkgairport.com

hongkongintrntnlairport.com

honoluluairport.net

honoluluintlairport.com

hoteldelaeropuerto.com

houstonairport.net

houstonbushintercontintalairport.com

houstongbushintercontinentalairport.com

houstoniahairport.com

houstonintercontinentalairport.com

iahhoustonairport.com

iahintercontinentalairport.com

informacionaeropuerto.com

internationalairportalmanac.com

internationalairportalmanac.net

internationalairportinfo.com

internationalairportsalmanac.com

internationalairportsalmanac.net

internationalairtrips.com

internationalairportalmanac.com

jacksonvilleflairport.com

jetplanesinc.com

justintimeairport.com

justintimeflight.com

justntimeairport.com

justntimeflight.com

justntimeticketing.com

justntimetickets.com

justntimetrips.com

kennedyairport.net

kennedyjfkairport.com

keylargolodge.com

laairport.net

laairports.com

laguardialgaairport.com

lainternationalairport.com

lasairport.com

lasvegasairport.net

lasvegasmcarranintairport.com

lauderdaleairport.com

laxairport.com

laxtrips.com

lgwairport.com

lhrairport.com

limairport.com

limajorgechavezintlairport.com

limaperuairport.com

londonairportinfo.com

londongatwickairport.com

londongbairports.com

londonheathrow.net

londonheathrowlhrairport.com

londonlgwairport.com

londonlhrairport.com

lotterygivutix.com

madairport.com

madridairport.net

manchestermanairport.com

mcoairport.com

mdwairport.com

memairport.com

memphisairport.net

memphismemairport.com

mexairport.com

mexicocityairport.com

miaairport.com

miaairport.net

miaairportauthority.com

miaairportauthority.net

miaairporttrip.com

miaairporttrips.com

miainternationalairport.com

miainternationalairport.net

miamiairportapartments.com

miamiairportcorporatesuitrs.com

miamiairportcorpsuites.com

miamiairporthotel.com

miamiairportlodging.com

miamiairports.com

miamiairporttransportation.com

miamiairporttrips.com

miamiairprtcorpratesuites.com

miamiapartments.net

miamiintairport.com

miamiinternationalairport.net

miamiintlairport.com

milanintairport.com

milanmxpairport.com

minneapolisairport.net

minneapolisstpaulinternationalairport.com

minneapolisstpaulmspairport.com

moscowintlairport.com

mspairpor.com

mucairport.com

mundialaerolineas.com

mundialaeropuertos.com

mundialaviones.com

mundialterminal.com

mundialterminales.com

munichmucairport.com

mxpairport.com

nassuaairport.com

newarkewrairport.com

neworleansairport.net

neworleansintairport.com

neworleansmsyairport.com

newyorkairport.net

newyorkairports.net

nrtairport.com

nyjfkairport.com

nylgaairport.com

nylgwairport.com

oficinadelaeropuerto.com

oharechicagoairport.com

ohareord.com

ohareordintlairport.com

ordairport.com

ordairport.net

orlandoairport.net

orlandointairport.com

orlandomcoairport.com

oryairport.com

osakaintairport.com

osakakixairport.com

palmademallorcaairport.com

panamaairport.com

parisairport.net

pariscdgairport.com

parisoryairport.com

paristrips.com

philadelphiaairport.net

philadelphiaphlairport.com

phlairport.com

phoenixairport.net

phxairport.com

pittsburgairport.com

pittsburghpitairport.com

pmiairport.com

preclearsecurity.com

rent4cents.com

rentairportoffice.com

rioairport.net

riodejaneirointlairport.com

rockymountainairtrips.com

rockymountaintrips.com

romeairports.com

romefcoairport.com

ronaldreagandcaairport.com

ronaldreaganwashingtonnationalairport.com

saltlakeairport.com

saltlakeairport.net

saltlakecityairport.net

saltlakecityslcairport.com

sanairport.com

sanfransiscoairport.com

sanintairport.com

sanjoseirport.com

sanjoseirport.net

sanjosesjcairport.com

sanjosesjcintairport.com

sanjosesjoairport.com

sanjuanairport.com

sanjuanairport.net

santiagochileairport.com

santiagointernationalairport.com

saopaulocongonhasintlairport.com

saopaulointlairport.com

sclairport.com

seaalrport.com

seattleairport.net

seattleintairport.com

seattleinternationalairport.com

seattleseaairport.com

seattletacomaintairport.com

selairport.com

seoulintairport.com

seoulkoreaairport.com

seoulkrairport.com

seoulselairport.com

sformtairport.com

sformtlairport.com

shopezfly.com

shopnflyairports.com

sinairport.com

singaporeairport.net

singaporechangiairport.com

sjcintairport.com

speedyclear.com

stlouisairport.com

stlouisairport.net

stlouisstlairport.com

sydairport.com

sydneysydairport.com

tampaairport.net

tampaairportsuites.com

tampahotel.net

tampaintairport.com

tampaintlairport.com

tampatpaairport.com

tarmacfuel.com

tarponflats.com

telavivintairport.com

tokyoairport.net

tokyoairports.com

tokyohndairport.com

tokyointairport.com

tokyonrtairport.com

tokyotrips.com

torontoairport.net

torontoyyzairport.com

tpaairport.com

travelstopamerica.com

travelstopamerica.net

travelusatoday.com

travelusatoday.net

txntime.com

usairport.net

usairporthotels.net

usairportinfo.com

usairportinfo.net

usairportinformation.com

usairportinfrastructure.org

usairportlodging.com

usairportlodging.net

usairportrentacar.com

usairportrentacar.net

usairports.net

usairportspark.com

usairportsparking.com

usairporttransportation.com

usairporttrips.com

usairporttrips.net

usairportwarehouse.com

usairtrips.com

ustrips.net

vegasairport.net

viajarus.com

viajarusa.net

viajesbarato.com

wapairportsamerica.com

wapairtix.com

wapairtx.com

wapflightsaroundtheworld.com

washingtonairport.net

washingtonairportbiz.com

washingtonairportoffice.com

washingtondcaairport.com

washingtondcairport.com

washingtondcairport.net

washingtondciadairport.com

washingtondullesairport.com

washingtonnationalairport.com

westerntravel.net

westemtrips.com

worldairportinfo.com

worldairportinfrastructure.org

yvrairport.com

yyzairport.com

zapairtix.com

zaptrip.com

zaptrips.com

zrhairport.com

zurichintlairport.com

The system is further programmed to utilize these domains in responding to a members selection of a particular airport for departure and/or return flights. Also, for providing various of the services, the system utilizes the following Internet addresses:

Airlineterminals.com

Airport Concessions.com

Airportdutyfreeshops.com

Airportindustrial.com

Airportoffices.net

Airportrentals.net

Airportsuites.com

Airportvalet4u.com

Airportvaletpark.com

Allaboutairports.com

Airportamericabanc.com

Airportamericabank.com

Aiportbanc.com

Airportbankamerica.com

Buyeasyairlinetickets.com

Cheapezairlinestickets.com

Cheaptx.com

Easyairlinetickets.com

Ezairlinetickets.com

Ezairportparking.com

Ezaircharters.com

Ezfast airports.com

Ezflightinsurance.com

Fastezairports.com

Freeairtx.com

Justintimeairport.com

Justintimeflight.com

Justintimetrips.com

Justntimeticketing.com

Lotterygivutix.com

Rent4cents.com

Usairportspark.com

Shopezfly.com

Shopnflyairports.com

As previously indicated, AA membership is obtained by simply logging in the first time and following filling out of name, address, phone, fax, e-mail, cell phone number, the member's credit card is assigned a pin number. Members receive a free e-mail if they so desire. After enrollment the AA member simply logs-on with member password and then scans Flight information, orders tickets which are delivered online via (ezflightinfo.com, eztxrez.com, 1clicktx.com) All .coms mentioned herein are owned by AA. If the member is cutting it close, or on the way to the airport, the member can go online or electronically communicate through a palmtop, laptop computer, cell phone, or WAP phone (WAPairtx.com, WAPairtix.com). Tickets can be printed out either at AirportAmerica Kiosks 11 (see FIG. 1) located strategically throughout the airport through a partnering with the local sponsor airport, or on a computer printer. The reservations are verified visually at the gate, or verified electronically at the gate (1clicktx, buyeasyairlinetickets, easyairlinetickets, ezairlinetickets).

If a member's plans unexpectedly change or if a flight is cancelled or delayed the member is instantly notified by an AA automatic alarm on a palm or computer, or via cellular phone on the go thru AA chip or Internet connect thru AA icon on WAP phone. If really tight for time the member can elect to go to justntimetrips.com, justntimeairport.com, justntimeflight.com; airportvaletpark.com or airportvalet4u.com. Through justntime the member can arrange to drive to the terminal where the valet station closest to his concourse will take the member's car, check his bag, and point out the required concourse and gate. The member also can use an AA computer terminal to printout tickets and itineraries as the member rushes right to the gate. If the AA member needs a cart to expedite travel to the gate, it is there, he leaves it at the gate and it will be picked up later. All this is automatically billed to the AA member. A member can check AA for up to the minute weather en route via just 1 click to ezweatherchk. If the flight is missed, the member can just click to ezaircharters. AA will arrange for charters from the departing airport that by agreement are on standby.

A member can change travel plans on the run thru use of a palm, an iCell phone 22, cell phone 17, laptop 20, or at an AA kiosk 11 and/or connectors provided at the airport (for example—ATL). The member can obtain a text confirmation at an AA kiosk 11 (computer printout) or at a gate airline link.

The member can have rent-a-car pickup and return at an AA affiliate valet stand. The valet will have a car ready at a destination airport valet stand when the AA member deplanes in a destination city. The valet gives the member an AA stub. At the end of the trip the AA member may opt to leave the rent a car at the valet stand.airportvalet4u.com. All AA affiliated Airport hotels and suites must provide pickup and return of AA member and luggage.

For reserve parking in the building, AA e-mails to the member the location of the reserved parking spot, for example, “North daily 3rd level, any of spaces 45-56”.

Through use of AA's Cartracker, a member can scroll thru a parking garage map displayed by AA on a monitor, permitting the member to palm, iCell phone 22 or cell phone 17 mark the location in the parking building. Upon return to a home city, and while going to the parking garage, a member can just scroll through maps of parking structures to locate a blinking light on iCell parking garage map indicating the location of car. In one embodiment, an infrared beam crosses reserved parking spaces. The beam is released by the member inserting their AA pin number in a key pad on adjacent stanchion, otherwise interruption of the beam sets off the alarm. Release of the beam is sent to an affiliate's computer in the garage, and sent on to AA local web parking page. When the member plugs in a pin number that disengages the beam, such action notifies the parking garage computer that the space reserved for the member is occupied by someone else. If a nonmember drives a car in the space the interrupted beam sets off an alarm.

An AA member is also eligible for lottery and AA points toward “feeairtx.com” and “giveutx.com”, and can collect visa miles for AA affiliate purchases in addition to the discounts.

A courier delivery service can be used by a member to retrieve needed merchandise from local stores for delivery to a hotel or airport (subcontractors/affiliate).

A member can order a personal valet to directly pick up baggage, and drive the member to an airport from a hotel, and assist with check in.

As previously indicated, a member can connect to AA semi-official websites of the world's major airports (which are AA owned and controlled domains). AA owns at least one and usually several of the most common domain names of the fifty or more busiest airports in the world, each of which is cross-linked so that reference to any portion of an airport name by an AA member will lead to the web site and to an AA portal through metatags. AirportAmerica is the portal to domestic and overseas AA owned websites.

Members are provided discounts via AA bids to affiliates who provide rent-a-car, hotels, apartments, temporary office suites, restaurants, travel packages thru AA owned websites such as rent4cents.com, ezairportoffice.com, cheapairportoffice.com

AA provides Airport Facilities Information to members via pull-down menus or coice communication for the following (this list may be expanded):

A. Airline lounges

B. Conference Center

C. Financial Services—AA sponsored ATM, cash advances on credit cards, travelers checks, money orders, foreign currency exchanges, ATM

D. Locker Rental

E. Lost and Found

F. Parking

G. Post Office

H. Visitor Info

I. Information translated into passenger's choice of 7 languages

A unique function provided by the AA system is STANDARDIZATION—a complete range of services available in each member airport set out in the AA web site credited to that airport, are linked like spokes of a wagon wheel to the AA hub/portal. The AA portal is the brains, the operations center (OP. Center), the clearing house. The OP. center continuously updates all information, individual of a member airport websites, and maintains and continuously improves the website for the benefit of the airport. When a member logs on to the site the airport gets primary billing at a fraction of the cost of attempting to maintain such a site itself. All services listed are available at all AA airports.

Queries are instantly transmitted to the AA OP Center via interactive computer-Kiosks 11 at the intersections of concourses, and gates and other strategic high traffic areas of the terminal. For example, assume a 1-800-400-1024 connection to AA for cell phone users for Ft Lauderdale (FLT), weather, and other information, reservation, ticketing. Any other areas can be simultaneously connected. Thru affiliate relationships with companies in the cutting edge of WAP technology, iCell and cell phone access will become the Internet access for mobile links to AA, and all information a member requires while on the run. AA stores the information accessed thru pin numbers or cookies.

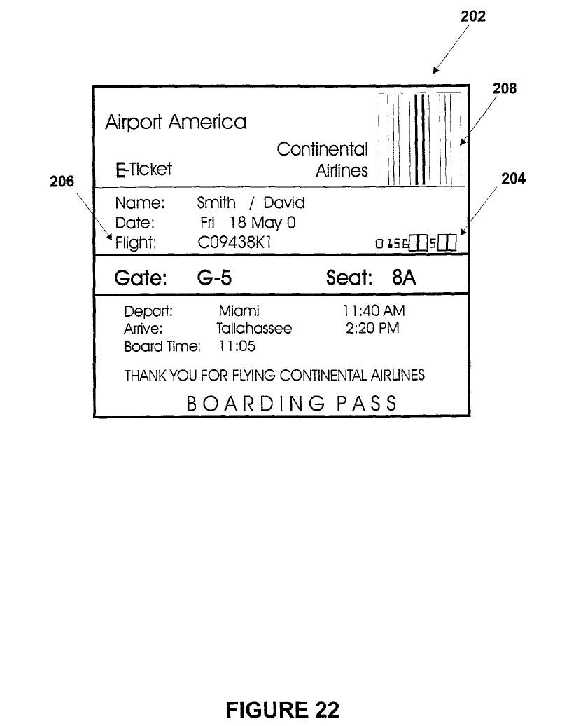

Printouts of justntimeticketing.com can be obtained by downloading to a 3″×3″ wireless printer which can be clipped to the waist or printed while in a briefcase, at AA interactive remote-Kiosks 11 located at the intersection of each concourse and terminal and/or out in concourse or local airport information center. An example of an AA e-ticket 202 is shown in FIG. 22. Note that the coded marks 204 to the right of the “Flight:” number provide a security clearance means for a member to obtain fast security screening or checkout.

AA Pre-Clearance—this is an important part of the AA seamless airport and air travel concept. Seamless connotes without bottlenecks. One of the major annoyances of the airport experience is the holdup at security when going from the central terminal to board the flight, so eliminating this delay helps to promote the AA seamless argument. Pre clearance involves AA as an agent for the FAA. AA conducts a sufficient inquiry of those members who elect this aspect of membership to enable AA to provide adequate information to the FAA to conduct a thorough security check, in order to obtain an expeditious security clearance to bypass or breeze through security.

As indicated, AA expedited pre-clearance is the key to a member obtaining expedited Access through security to the gate. This is accomplished by an FAA approved pre-clearance security check of an AA member who volunteers for the Fast Security Check Program as a result of the AA member filling out an AA Electronic Personal Security Questionnaire [ESPQ] which is then submitted to the FAA. Upon approval by the FAA of the member following computer investigation, the AA member will be eligible for preflight implementation of pre flight security clearance through a security checkpoint to the gate which is evidenced by an encrypted code 204 or security stamp on e-ticket 202 (see FIG. 22).

The questionaire requires:

Member name,

Address

Phone numbers

social security number,

photo, and

electronic finger and face print for identification.

This EPSQ form provides fast encrypted security verification for each trip based on computer update of EPSQ. This usually results in pre-clearance, and the AA member just walks through the unmanned automated security gate. As the bar code 208 on the AA member's e-ticket makes contact with the infra-red beam at this unmanned station, the automated gate opens. The AA member goes through the security station en route to gate.

In the alternative, the AA member presents the e-ticket with encrypted security code or stamp to an attendant, who verifies through a computer check by passing a wand over the e-ticket bar code 208. If the AA member passes this five to fifteen second process, the AA member is waived through a manually operated Green Lane, thus bypassing any queue or hold up at the security checkpoint. Approval gives clearance and the levels of access through Green Lane.

Note that AA provides the system with domains associated with pre-clearance. For example, Preclearsecurity.com, and Fastsecuritychek.com are provided.

FIGS. 3 through 17 show examples of pull-down menus available to a member for obtaining desired travel information, and making reservations. Other pull-down menus can be configured for expanding the usefulness of the system.

An example of an AirportAmerica (AA) member utilizing the present system to make his/her airport, flight and travel experience easier, faster, cheaper and friendlier, will now be given. It is the inventor's understanding that the following combination of unique and non-obvious features provide what no other airport site is currently offering. AA owns at least one .com domain name of every major (top 50) airport in the world and of the largest five or ten AA owns several. For example, Atlanta: Atlantahartsfield.com, atlantainternationairport.com, atlintlairport.com, Hartsfieldatlantainternationalairport, atlhartsfieldairport.com, atlinternationalairportcom, atlhartsfieldintlairport.com, atlintairport.com are all separate AA owned domain names. They will be separate-linked web sites, all linked, and all leading to the AA portal. The links are the spokes to the hub, AA is the hub. Each Atl web site or any combination of words for that airport through meta-tags, etc will lead to the standardized Atl website, and then to the AA portal. For example, say an AA member, Bond is his name is in the company office in Cincinnati, who at 4:00 pm notices that a conference for the Americas is starting today in Miami and member of in the Chilean delegation is speaking tomorrow a.m. is the business contact he has been trying to reach in Chile. He normally could never make a flight to attend.

Bond can attend through use of his AA membership. He clicks to AA, he clicks to AA on his personal computer, inputs his pin number, then goes to “C” for Cincinnati in the “Departing Airport”, and “M” for Miami for “Arrival Airport” and obtains all of the flights for today. Alternatively, he can use his cell phone 17, or iCell phone 22 to depress the “2” key, for example, programmed to dial the AA “800” number, to accomplish the aforesaid. The AA system identifies his cell phone, or iCell number, and retrieves his profile to obtain his PIN number automatically. In luck, there is one last flight leaving in just over one hour. Bond runs down to the parking garage, jumps in his car and takes out his iCell phone, and using voice recognition says “Internet”, then “Airport America Depart CIN after 4:00 pm today Arrive MIA today.” AA responds “you are booked business class, aisle 24b, as is your preference Mr. Bond (from profile on file) you may proceed to concourse “A, gate 4” to pick up your ticket (with AA the maximum discount is automatically credited), and board or get a printout at any AA kiosk 11, one is located at the information booth or in the terminal at the intersection of concourse A. Do you wish to go ezaiportparking.com or aaavalet.com? If you select ezairportparking.com north daily is open, but we notice it is less than one hour until your departure, we recommend aaavalet.com.” Bond clicks ezparking and requests expedited as an option in justntimeairport.com. He then clicks on up to the minute traffic map to the airport and sees a bottleneck flash on the interstate, exits around the fender bender, pulls up to valet fifteen minutes later and leaves the car. He is pre-cleared through security by hand wand by security personnel at valet who have been notified that he has elected expedite. The security person accompanies him through the security bypass and around those long lines, and he then places his briefcase and hand luggage in a waiting AAcart and proceeds to board just in time. He then settles in the seat, but before turning off his electronic equipment, he orders the I-phone or WAP phone to have a club limousine waiting at MIA, and to make reservations at the closest airport suites hotel, and bids $75 for one bedroom with a computer port. In a few seconds a confirmation number appears with the AA discount built in. He then commands Miami downtown restaurants. In a flash a list of preferred restaurants and a rating for price and quality appear. He picks the Biltmore in the expensive category because the conference is there and he can have a drink. He makes rez.com for 8:30 P.M. Bond arrives in Miami flicks on the iCell reviews the e-mail and finds the Black Lincoln town car club limo is waiting upstairs concourse B at the AA valet stand. He stops at the AA kiosk 11 near his gate, selects general information from the home page, and then clicks terminal layout. He locates the AA valet at Concourse B. Bond then puts in his AA trip PIN number and in a few seconds receives page one of hard copy of a reservation at Airport Villas with a map and a note that an AA travel pac (drop kit) is in his room. Page 2 of the printout confirms the Biltmore. Page three confirms the Ralph Lauren blue dress shirt, underwear and socks he ordered from AA “airportvalet4u.com” will be delivered to his hotel by “airportvalet4u.com” courier by 7:00. p.m. If he has any questions the driver's cell number and store location and telephone number are included.

Although various embodiments of the invention have been described above, they are not meant to be limiting. For example, those of skill in the art may recognize certain modifications to these embodiments, which modifications are meant to be covered by the spirit, and scope of the appended claims. Such a modification, for example, may be to expand the present method and system, or convert it, to include railroad scheduling, bus scheduling, ship scheduling, and so forth.

What is claimed is:

1. A method for providing a computerized interactive rapid response travel planning and reservation system comprising the steps of:
providing a website for members to access said system via the Internet;
enrolling a new member into said system via pull-down menus or voice communication, for obtaining a name, address, telephone number, credit card information, and profile information including travel preferences such as carrier seating, travel class, self or valet parking, and other options, said enrollment step terminating with the assignment of a unique PIN number to the member;
maintaining a database containing active PIN numbers of said members;
providing means in said system for permitting a member to use any one of a plurality of devices including a WAP (Wireless Application Protocol), a cell phone, a WebTV, a personal computer, an iCell telephone, a mobile telephone, and a palm computer, to access and communicate with said system via the Internet, through use of either voice queries, responses, and commands, or computerized menu driven prompts, commands, and responses;
programming the system to respond to a member's request for access by first checking the member's PIN number against said database of active PIN numbers, and if the PIN number is active establishing either voice or data communication with the member dependent upon the type of device the member has used to access said system;
prompting a member, upon access to said system, to advise of travel arrangements to be made;
maintaining a database web site addresses for travel service and related providers including airports, airlines associated with each airport, ground transportation providers (railroads, limousines, etc.), hotels, retailers, ship lines, restaurants, and other providers;
responding to said member's responses to prompts, for immediately contacting necessary providers to make reservations for the member, and to issue any necessary tickets either directly to said member, or arrange for the member to pick-up the tickets at a predetermined location;
issuing said member either one of a written or oral confirmation of all travel plan arrangements made; and
saving the confirmation in said system for at least the period of time said member will be traveling, for permitting by said member at any time during the travel period.

2. A method for providing a computerized interactive rapid response Internet accessed air travel planning and reservation system comprising the steps of:
forming a database including airport domain names, ground transportation services, domain names, hotel domain names, resaurant domain names, department store domain names, and airline domain names;
forming a database including individual PIN numbers of active members of said system, along with travel preference profiles for each active member;
communicating over the Internet with active members of said system, said system including means permitting a member to so communicate through use of any one of a plurality of devices including a WAP (Wireless Application Protocol), a cell phone, a WebTV, a personal computer, an iCell telephone, a mobile telephone, and a palm computer;
responding to a member's request for making travel arrangements;
prompting said member to provide departure airport, arrival airport, desired arrival time, hotel preferences if any, ground transportation, valet or self parking needs, restaurant needs, length of stay, and other travel related information;
contacting via the Internet all necessary travel service providers to arrange for all travel requirements of said member;
providing Kiosks at different location within the concourses of each airport to permit members a direct link to said system;
transmitting airline tickets directly to a member for printout at the members site, or providing tickets to a member via said airport Kiosks; and
storing the travel itinerary access by the member during the time period covering the associated trip.

3. A travel arrangement system for enabling a user to select custom travel plans, to be apprised of real-time travel services, conditions and status, and to self-process such travel plans, said system comprising:
a computer accessible by a user, said computer being adapted for connection to the Internet through a communication link;
a central processor connected to said Internet, including a modifiable database for storing and supplying real-time information data associated with travel services, conditions, activities and statuses of various individual travel service providers and travel sites associated with said providers to the user through said computer;
said central processor further being adapted to receive input from said user related to selection of travel services, travel plans, activities associated with travel, or any combination thereof, and process said input for establishing travel arrangements with said corresponding travel service providers;
a plurality of servers each associated with one of said travel service providers, connected to said central processor for continuously providing and updating the real-time information data stored in said modifiable database; and
a plurality of travel ticket dispensers each located at said corresponding travel service provider sites for printing travel tickets to said user in response to the processing by the central processor and coded input request of said user for retrieval.
